(19) United States
(12) Patent Application Publication
(10) Pub. No.: US 2026/0093992 A1
(43) Pub. Date: Apr. 2, 2026

(54) FAST LONG-CONTEXT FOR TRANSFORMER ATTENTION MECHANISM

(71) Applicant: ROYAL BANK OF CANADA, Toronto (CA)

(72) Inventors: Yongchang HAO, Edmonton (CA); Mengyao ZHAI, Vancouver (CA); Hossein HAJIMIRSADEGHI, Vancouver (CA); Sepid HOSSEINI, Vancouver (CA); Frederick TUNG, North Vancouver (CA)

(21) Appl. No.: 19/341,362

(22) Filed: Sep. 26, 2025

Related U.S. Application Data
(60) Provisional application No. 63/699,985, filed on Sep. 27, 2024.

(51) Int. Cl. G06N 3/088; G06N 3/045

(52) U.S. Cl. CPC G06N 3/088; G06N 3/045

(57) ABSTRACT

A fast long-context attention mechanism can be used with any trained transformer model. The best context ranges of tokens for the attention mechanism can be dynamically selected from segments formed from the tokens.

### RELATED APPLICATIONS

The current application claims priority to U.S. Provisional Patent 63/699,985, filed Sep. 27, 2024 and titled “Fast Long-Context For Transformer Attention Mechanism” the entire contents of which are incorporated herein by reference.

### TECHNICAL FIELD

The current disclosure relates to transformer models and in particular to providing long-context for the attention mechanism of the transformer model.

### BACKGROUND

Transformer models demonstrate an extraordinary ability on different sequential processing tasks, including language modeling, image classification, translation, and many more. Transformer models take each input as a sequence of tokens and compute the embedding of each token for downstream tasks. Among all components of Transformer models, the dot-product attention mechanism has been shown to be critical to the success of Transformer models. It not only enables parallel computation of sequences during training, but also provides better sequences modeling compared with recurrent models.

Despite being at the core of Transformer models, the dot-product attention is not ideal for long context data. The time to process the dot-product for each token increases with context lengths, significantly slowing down the throughput on long-context data. Moreover, the maximum context length is limited during training, resulting in an inability to inference on long-context tasks. Yet, many real-world applications are naturally long-context. For example, a single code file could easily have more than 10K tokens. However, Llama-2, a widely used Transformer-based model, is incapable to process the full source code because it has a maximum context length of 4K tokens.

To improve Transformer's long-context performance, a line of research proposes to replace the original attention with some faster variants. One such example is attention kernalization, which reformulate the dot-product attention as a kernel and approximate the kernel with linear operations. By reordering the matrix chain multiplication, the kernalization methods reduce the time complexity to O(t) for context of length t. However, such methods require a training process to fit the approximations, which becomes more and more infeasible given the fast parameter scaling with context length of the current Transformer models.

Another challenge with Transformers is their long training times, making it essential to leverage pre-trained models effectively without the need for extensive retraining. One technique for accelerating the attention mechanism on long context, without requiring re-training of the Transformer is to evict previous tokens used in each decoding step. For instance, StreamingLLM proposes to only use the constant-length recent tokens and discard all other but the first tokens. Although being able to accelerate the inference on long-context data, these methods lose the previous information in the context potentially critical for future use.

An additional, alternative and/or improved method of extending the context length of transformers is desirable.

### BRIEF DESCRIPTION OF THE DRAWINGS

Further features and advantages of the present disclosure will become apparent from the following detailed description, taken in combination with the appended drawings, in which:

FIG. 1 depicts a decoder-only transformer with fast long-context;

FIG. 2 depicts details of the fast long-context functionality;

FIG. 3 depicts a method of providing fast-long context to a transformer model;

FIG. 4 depicts a method of providing fast-long context to a transformer model;

FIG. 5 depicts a further method of providing fast-long context to a transformer model;

FIG. 6 depicts a method of dynamic restructuring of segment size used in the feast-long context mechanism.

FIG. 7 depicts a further method of dynamic restructuring of segment size used in the feast-long context mechanism;

FIG. 8 depicts the dynamic restructuring of segments;

FIG. 9 is a results graph showing the perplexity vs. input sequence length;

FIG. 10 is a result graph showing the accuracy vs. number of repeats;

FIG. 11 depicts results of the perplexity evaluations;

FIG. 12 depicts further results of the perplexity evaluations;

FIG. 13 depicts results of long-context benchmarks;

FIG. 14 depicts evaluation results of generation without prompts;

FIG. 15 depicts evaluation results of the effect of the hyper-parameter n; and

FIG. 16 depicts evaluation results of the effect of the hyper-parameter k.

### DETAILED DESCRIPTION

According to the current disclosure there is provided a method for use in determining context keys for an attention mechanism of a transformer model, the method comprising: generating a plurality of segments, each segment combining a plurality of respective token key mappings generated by mapping the respective token keys using a random feature matrix Ω∈R^{n×d}; generating a token query mapping by mapping the token query using the random feature matrix Ω; calculating attention scores between the token query mapping and each of the plurality of segments; and returning the token keys of m segments with the highest attention scores.

In a further embodiment of the method, the random feature matrix is Ω∈R^{n×d}, where each element in Ω is sampled from N_{0,1}.

In a further embodiment of the method, each token key mapping is calculated according to:

$${ϕ}_{Ω} ( k ) := \frac{1}{\sqrt{n}} ( exp ( {ω}_{1}^{T} k - \frac{‖ k {\vert \vert}^{2}}{2} ) , exp ( {ω}_{2}^{T} k - \frac{‖ k {\vert \vert}^{2}}{2} ) , … , exp ( {ω}_{n}^{T} k - \frac{‖ k {\vert \vert}^{2}}{2} ) )$$

where: k∈ [symbol] ^{d} is the token key; ωᵢ∈ [symbol] ^{d} is the i^{th} column of Ω.

In a further embodiment of the method, each segment is generated according to:

$${\overline{ϕ}}_{Ω} ( {k}_{j : j + c} ) := \frac{1}{c + 1} {\sum }_{l = 0}^{c} {ϕ}_{Ω} ( {k}_{j + l} )$$

where: the number of key tokens combined in the segment is c+1.

In a further embodiment of the method, the attention score is calculated according to: a_{l:l+c}:=φ_{Ω}^{T}(q)φ̅_{Ω}(k_{l:l+c}) where: a_{l:l+c} is the attention score for the segment of token keys kₗ to k_{l+c}.

In a further embodiment of the method, each segment is formed from at most c+1 token keys.

In a further embodiment of the method, the method further comprises: receiving a new token key and new token query; mapping the new token key and new token query to, respectively, a new token key mapping and a new token query mapping using the random feature matrix; adding the new token key mapping to a sliding window buffer; calculating attention scores between the new token query mapping and each of the plurality of segments; and returning the token keys of m segments with the highest attention scores and the token keys of the token key mappings in the sliding window buffer.

In a further embodiment of the method, the method further comprises: receiving a new token key and new token query; mapping the new token key and new token query to, respectively, a new token key mapping and a new token query mapping using the random feature matrix; combining the new token key mapping with an existing segment; calculating attention scores between the new token query mapping and each of the plurality of segments; and returning the token keys of t segments with the highest attention scores.

In a further embodiment of the method, the method further comprises: determining that the plurality of segments should be dynamically restructured; determining a new segment length (c′) indicating a maximum number of token key mappings combined together in each new segment; and calculating the new segments according to:

$${\overline{ϕ}}_{Ω} ( {k}_{j : j + {c}^{′} - 1} ) := \frac{1}{{c}^{′}} {\sum }_{l = 0}^{{c}^{′} - 1} {ϕ}_{Ω} ( {k}_{j + l} ) .$$

In a further embodiment of the method, determining that the plurality of segments should be dynamically restructured comprises: calculating \sqrt{t}; determining that dynamic restructuring is required when \sqrt{t}∈N; and determining that dynamic restructuring is not required otherwise, where t is a total number of tokens in a current context.

In a further embodiment of the method, determining that the plurality of segments should be dynamically restructured comprises one or more of: determining that the number segments has exceeded a threshold; and determining that a ratio of the number of segments to the segment length has exceeded a threshold.

In accordance with the present disclosure there is further provided a system for use in determining context keys for an attention mechanism of a transformer model, the system comprising: a processor for executing instructions; a memory storing instructions, which when executed by the processor configure the system to provide a method according to any one of the methods above.

In accordance with the present disclosure there is further provided a non-transitory computer readable memory storing instructions, which when executed by a processor of a system configure the system to provide a method according to any one of the methods above.

A training-free approach for accelerating inference of Transformers dynamically selects the most relevant context ranges of the tokens to use. For any pre-trained Transformer, this approach can instantly extend the maximum context length while reducing overall complexity to O(t^{1.5}). This approach can reliably identify the most dominant tokens with high probability and achieves good performance with reduced time complexity, offering a practical solution for efficient long-context processing in Transformers.

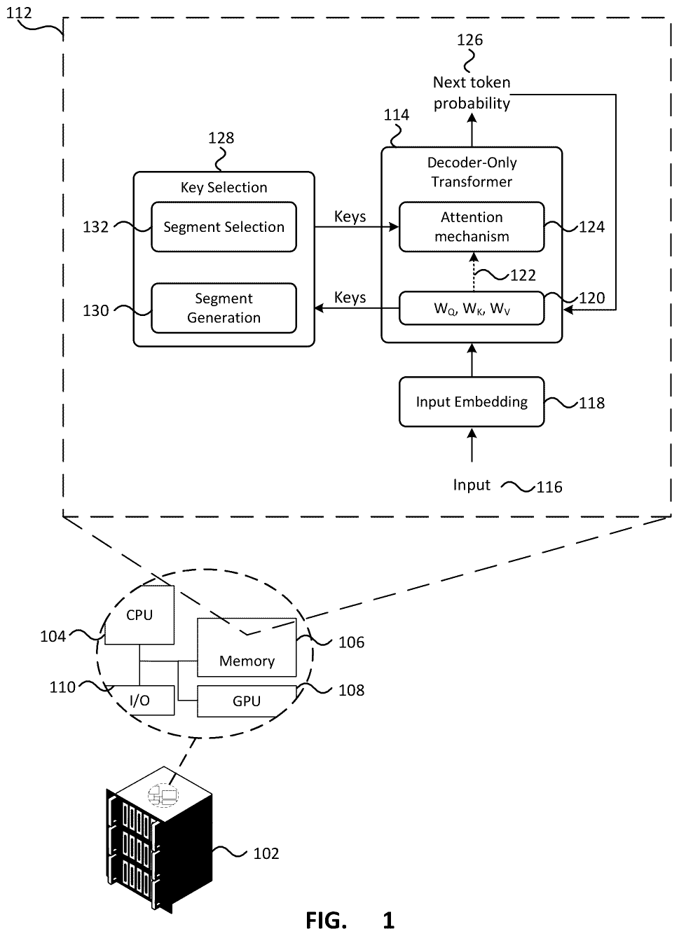

FIG. 1 depicts a decoder-only transformer with fast long-context processing. The processing is depicted as being performed by one or more servers 102 or computers. It will be appreciated that the processing may be performed by a plurality of computing devices that are communicatively coupled together by one or more networks. The one or more servers include one or more processors 104 and memory units 106. The servers may also include one or more Graphic Processing Units (GPUs) 108, or other specialized components for efficiently executing required calculations. The servers may also include one or more input/output (I/O) interfaces 110 which may be used to connect one or more other computing devices, including for example network interfaces, displays, keyboards and mice, etc. to the one or more servers. The memory units 106 of the server include instructions which when executed by the processors 104, and other processing units such as the GPUs 108, configure the one or more servers to perform various functionality including the transformer functionality 112.

The transformer functionality 112 is depicted as comprising a decoder-only transformer 114, although other transformer architectures could be used including encoder-only transformers and encoder-decoder transformers. An input 116, such as a prompt or portion of an output, is provided to input embedding functionality 118 that receives the words, parts or words, parts of speech, etc. and outputs tokens. The tokens may be vectors of a relatively high dimension, which may be fixed for all tokens. The input embedding functionality 118 may be provided by a neural network whose weightings are learned through a training process on a corpus of data. The current application assumes that the input embedding functionality is already trained and as such the training process is not described in detail herein. The tokens are provided to the decoder only transformer functionality 114 which applies weightings, ω_{Q}, ω_{K}, ω_{V}, to the tokens in order to generate query, key and values corresponding to the tokens. The weightings ω_{Q}, ω_{K}, ω_{V} are matrices whose values are learned through a training process. The weightings are assumed to be pre-trained and as such the training process is not described in further detail. The query, key, and values that result from applying the weighting matrices to the token comprise respective vectors.

In a normal decoder-only transformer the query, key and value vectors are provided to an attention mechanism as depicted by arrow 122. The attention mechanism 124 determines the attention between the query and each of the keys in the current context, using the values. The result from the attention mechanism is used to determine the probabilities of a next token 126 in the output, and select the next token, which can then be provided to the decoder-only transformer in order to generate another token of the output. It is clear that as the context size grows, the number of keys that need to be considered by the attention mechanism also increases and as such the computational complexity grows with the context size.

As described in detail further below, rather that processing all of the keys of the context by the attention mechanism 124, key selection functionality 128 is used to select the most important or relevant keys. The keys can be provided back to the decoder-only transformer functionality and processed in the same manner as the keys if the current key selection was not performed. As depicted, the key selection functionality 128 receives the keys, and query vectors of the current context. The keys are used by segment generation functionality 130 to generate a plurality of segments, each of the segments formed from a respective range of keys in the context. Segment selection functionality 132 uses an attention mechanism based on the current query and the segments in order to select the most relevant segments. The keys of the selected segments may then be provided to the transformer functionality 114 for processing. As the context size grows, the additional processing required by the key selection functionality in order to reduce the number of keys considered by the attention mechanism will reduce the overall computations required.

It is noted that the decoder-only transformer 114 depicted in FIG. 1 omits various components for clarity of the description. Further, the attention mechanism is depicted as a single headed attention mechanism, however, it will be appreciated that the same key selection process can be used with multi-headed attention mechanisms. Further, while a single layer of decoder is depicted, it is possible to use multiple layers of decoder mechanisms. Further, while FIG. 1 depicts providing key vectors to the key selection functionality, it will be appreciated that the key vectors, and the query vector, may be provided in various ways including as the vectors themselves, indices to the vectors or other techniques.

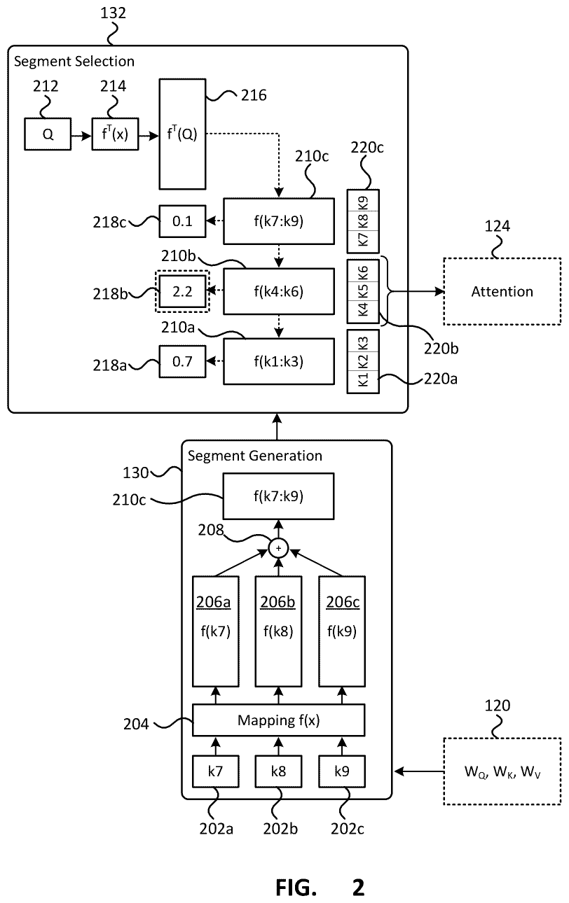

FIG. 2 depicts details of the fast long-context functionality. FIG. 2 depicts the segment generation and selection process with segments having a size of 3 keys. That is, each segment is depicted as being generated based on 3 keys. The keys may be received, or retrieved, in blocks or individually. Further, while FIG. 2 depicts generating each segment from 3 keys, it is possible to generate a segment from fewer than the maximum number of keys.

As depicted, 3 keys 202a, 202b, 202c are being processed into a corresponding segment. The 3 keys are depicted as k7, k8, k9, with the numbers providing indices of the keys position within the context. A mapping 204 is applied to each key vector to generate a respective key mapping 206a, 206b,206c. The mapping is depicted as a function ƒ(x) that maps the embedded token key to a random feature ƒ(kᵢ). The key mappings 206a, 206b, 206c may then be combined together to form a segment 210c. The segment is described by ƒ(k7:k9) indicating that the segment is formed based on keys k7, k8, and k9. The segments can be generated based on a random feature mapping of a plurality of keys. The segment generation is depicted for keys k7:k9. It is assumed that other segments 210a, 210b have been previously generated based on keys k1:k3 and k4:k6 respectively.

As described above, when generating a next token of the output, an attention score is determined between a query token and each of the key tokens of the context. During the segment selection 132, the token query vector 212 is used to select one or more of the segments. The token query vector 212 is mapped by a mapping function ƒ^{T}(kᵢ), which is the transpose of the mapping function ƒ(kᵢ). An attention score is then determined between the mapped query ƒ^{T}(Q) 216 and each of the segments 210. As depicted, there are 3 attention scores 218a, 218b, 218c. The segment, or segments, with the best attention score is then selected. In FIG. 2, segment ƒ(k4:k6) 210b has the best attention score of 2.2. Each of the segments 210a . . . 210c are associated with the respective keys or key ranges 220a, 220b, 220c that were combined together in the segment. The keys associated with the selected segment can then be provided to the attention mechanism 124 as described above. In FIG. 2, keys k4:k6 220b are associated with the selected segment and as such are returned.

Without loss of generality, the current description focuses on the single-head self-attention for simplicity. The self-attention operates on the level of sequences. Each sequence contains several token embeddings (x₁, . . . , xₜ) where every embedding is a vector in the high dimensional space R^{d}. Each embedding is mapped to respective query, key, and values by linear projections (qᵢ=W_{q}xᵢ, kᵢ=Wₖxᵢ, and vᵢ=Wᵥxᵢ). The attention score between the query and keys can be defined as:

$${a}_{i , j} := \frac{1}{{z}_{i}} ( j \leq i ) exp ( {q}_{i}^{T} {k}_{j} / \sqrt{d} ) , \qquad ( 1 )$$

For i, j∈[t], where t is the context length. [symbol] (j≤i)=1 when j≤i and 0 otherwise. Here, zᵢ is a normalization factor such that

$${\sum }_{j = 1}^{i} {a}_{i , j} = 1 .$$

The dot-product attention may then be calculated according to:

$${o}_{i} = {\sum }_{j = 1}^{i} {a}_{i , j} {v}_{j} , \qquad ( 2 )$$

The above indicates that oᵢ is a fusion of (v₁, . . . , vᵢ) weighted by the attention scores (a_{i,1}, . . . , a_{i,i}). The dot-product attention requires O(t) to generate a new token, resulting in an overall O(t²) time for the whole sequence. In order to reduce the complexity of the dot-product attention, both operations should not be quadratic in t.

As described with reference to FIGS. 1 and 2, the context can be reduced by selecting the important tokens and only considering those tokens instead of all tokens of the context. In the dot-product attention of equation (2), the attention score a_{i,j} represents the importance of the jth token to the current step i. To ensure the selected tokens are important, it is desirable to select an index set S so that for all j∈S:

j∈arg topk a_{i,i}, for l=1 . . . i,

Where arg topk provides the indices l of the top k attention scores. This gives an approximation of the original attention and reduces the compute to O(|S|). However, generating such an index set S takes O(t), which fails to improve the overall complexity. Accordingly, the best index set is approximated using segments that combine ranges of keys together. This approximation solves the problem in sublinear time complexity.

The key embeddings (k₁, . . . , kₜ) are managed as a hierarchical data structure having two layers of nodes. The bottom-layer nodes are the original key embeddings, depicted as keys 220a . . . 220c in FIG. 2. Each top-layer is the segment combining the associated keys, depicted as segments 210a . . . 210c in FIG. 2. This hierarchical structure enables the attention calculation to first search for important segments with the highest combined attention score and then use the tokens of the selected segment to approximate the attention for the attention calculation. The benefit of this approach is the reductio in time complexity. Assuming there are t tokens and each segment contains c tokens on average, then the overall query complexity is

$$O ( \frac{Tt}{c} + c ) ,$$

where O(T) is the time complexity to obtain the importance score for a segment. The term O(t/c) comes from calculating the importance of [t/c] segments and selecting the top ones. The second term O(c) is for computing the actual dot product attention scores according to equations (1) and (2) above.

To accelerate the search for the best segments, each segment can be provided as a representation that summarizes the bottom-layer key embeddings of the segment. The attention kernelization technique described in Choromanski et al. “Rething attention with performers” in International Conference on Learning Representations of 2021, incorporated hereinby reference in its entirety for all purposes, may be used. Specifically a mapping φ_{Ω}: [symbol] ^{d}→ [symbol] ⁿ is applied for all keys.

$${ϕ}_{Ω} ( k ) := \frac{1}{\sqrt{n}} ( exp ( {ω}_{1}^{T} k - \frac{{‖ k ‖}^{2}}{2} ) , exp ( {ω}_{2}^{T} k - \frac{‖ k {\vert \vert}^{2}}{2} ) , … , exp ( {ω}_{n}^{T} k - \frac{‖ k {\vert \vert}^{2}}{2} ) ) \qquad ( 4 )$$

Every element Ω∈ [symbol] ^{n×d} is sampled from [symbol] _{0,1}. and the vector ωᵢ∈ [symbol] ^{d} is the i^{th} column of Ω. After projection, the projected features are averaged together as the segment embedding. The embedding for a segment ranging from i to i+c can be calculated as:

$${\overline{ϕ}}_{Ω} ( {k}_{i : i + c} ) := \frac{1}{c + 1} {\sum }_{l = 0}^{c} {ϕ}_{Ω} ( {k}_{i + l} ) , \qquad ( 5 )$$

The segment embeddings can be pre-computed and stored. As new tokens are added to the context, segments, or the last segment can be adjusted based on the new token, or new segments added. Since each segment is the average of the projected features of the keys in the segment, different segments may have number of keys as part of it.

In order to search for the most important segments, it is possible to search for:

$${{arg topk}_{l}}_{\{ {a}_{l : l + c} : = {ϕ}_{Ω}^{T} ( q ) {\overline{ϕ}}_{Ω} ( {k}_{l : l + c} ) \}} \qquad ( 6 )$$

For

$$l ∈ \{ 1 , 1 + c , … , 1 + ( ⌈ \frac{t}{c} ] - 1 ) c \} .$$

This process only takes T=O(1) to obtain an importance score. Therefore, the total time is O(t/c) given that there are [t/c] segments. The obtained segments will likely contain the most important tokens that summed to the highest attention scores.

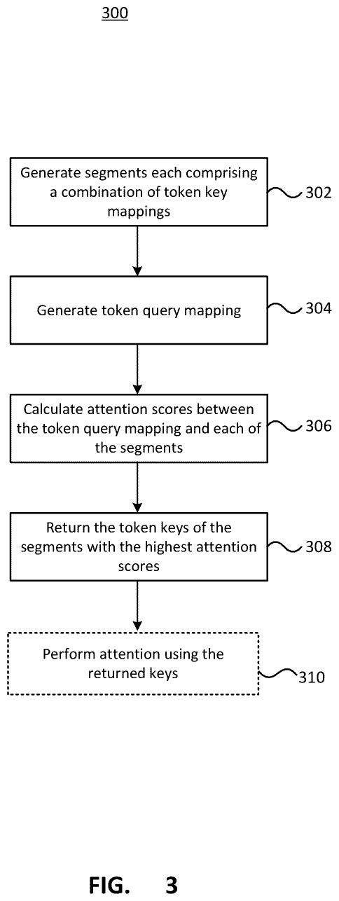

FIG. 3 depicts a method of providing fast-long context to a transformer model. As depicted in the method 300, segments are first generated as a combination of token key mappings (302). Each segment may be generated as an average of a maximum number of keys. The segments may be generated according to equations (4) and (5). A token query mapping (304) is generated and used to calculate attention scores between the token query mapping and each of the segments (306). Once the attention scores are calculated, the token keys of the segments with the highest attention scores can be returned (308). The number of segments selected can vary. The token keys of the selected segments can the be used in the dot-product attention (310).

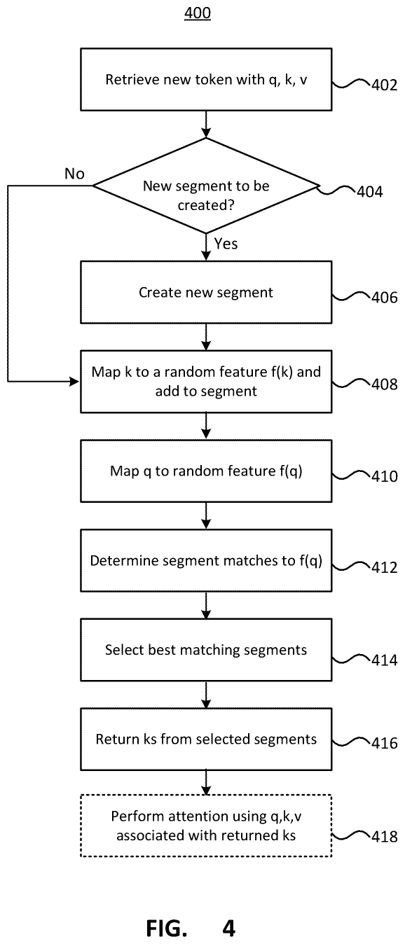

FIG. 4 depicts a method of generating segments. The method 400 generates segments as additional token keys are received. A new token is retrieved (402) and it is determined if a new segment should be created (404). A new segment may need to be created when the number of token keys in the current segment exceed a maximum value. If a new segment is to be created, the segment is created (406). Regardless of if a new segment is created or not, the token key is mapped to a random feature f(k) and added to the current segment (408). In order to adjust the average value of a segment, the number of key mappings in a segment may be tracked. The token query of the latest token may be mapped to a random feature (410). The query mapping is used to determine the matches to each of the segments (412). The best matching segments can be selected (414) and the keys, or indices of the keys, of the selected segments returned (416). The returned keys may be used in the dot-product attention (418).

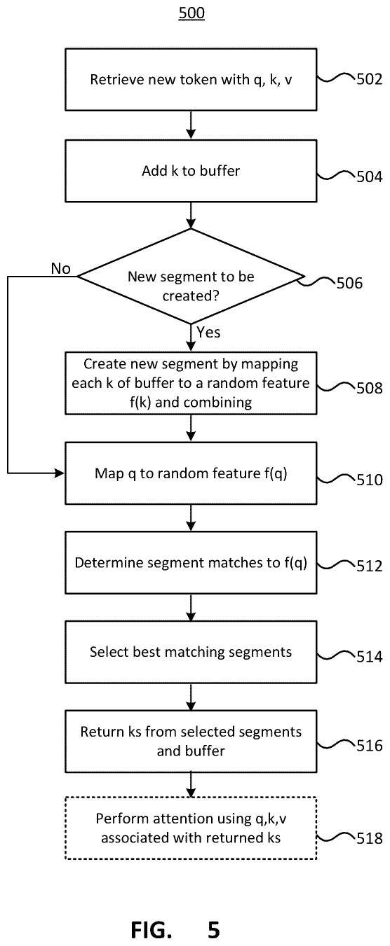

FIG. 5 depicts a further method of generating segments. The method 500 is similar to the method 400 described above, however rather than adding each new token key to a segment as it is received, individual token keys are first added to a sliding window buffer. As depicted, a new token is received (502) and added to a sliding window buffer (504). It is determined if a new segment should be created (506). A new segment may be created when the number of token keys in the buffer is equal to the number of keys used in the segment. If a new segment is to be created (Yes at 506), the new segment is created and each of the key tokens in the buffer are mapped to respective random features and combined together, for example as an average of the key mappings, in the new segment (508). The buffer may be reset. After creating the new segment, or if a new segment is not needed (No at 506), the query token is mapped to a random feature query mapping (510) and matches between the query mapping and each of the segments is determined (512). The best matching segments are selected (514) and the keys used in the selected segments, as well as the keys in the buffer returned (516). The returned keys may be used in the dot-product attention (518).

In the above, the computation time is proportional to the number of segments. If the segment size, i.e. the number of keys in the segment, remains the same, the number of segments will continue to increase along with the computation time. In order to keep the computation time approximately constant, the segment size can be periodically adjusted in order to keep the number of segments approximately constant.

With the accelerated searching, each query takes

$$O ( \frac{t}{c} + c )$$

time. The optimal asymptotic time complexity O(\sqrt{t}) is obtained when c=O(\sqrt{t}), indicating that the segment range should change with the length of the context. However, changing the segment range, or the number of keys in each segment, requires a reconstruction of all of the segment embeddings that takes O(t) time. To address this, dynamic restructuring may be used, which restructures the segments periodically. Various techniques can be used to determine when to dynamically restructure the segments. For example, the restructuring may be performed based on the number of segments, a ratio of the number of segments to the segment length, among others. As a further example, restructuring may be performed when \sqrt{t}∈ [symbol] . This restructuring schedule indicates that there will be maximum \sqrt{t}times of restructuring happening for t tokens, amortized to an O(\sqrt{t}) time for each query step.

For all other steps that \sqrt{t}∉ [symbol] , the tokens can be stored in a buffer, which serves as a sliding window with a maximum size of 2\sqrt{t}−1. Additionally or alternatively, new tokens can be added to further segments until restructuring is needed. The keys in the sliding window may be used in query along with the keys of the selected best matching segments. Although adding more tokens in the attention calculation, the asymptotic complexity remains O(\sqrt{t}) for each step.

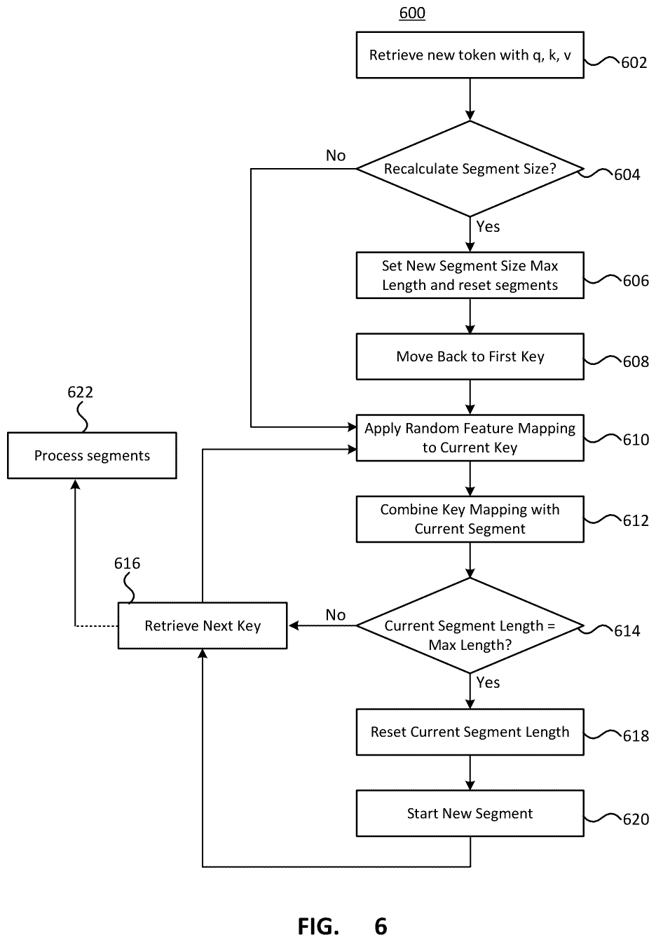

FIG. 6 depicts a method of dynamic restructuring of segment size used in the feast-long context mechanism. The method 600 can dynamically restructure segments as individual keys are received. The method 600 begins with retrieving a new token associated with respective query, key and value vectors (602). It is determined if the segment size should be dynamically changed (604), for example if \sqrt{t}∈ [symbol] . If the segment size should be changed (Yes at 604), the new segment size max length is set and the existing segments reset (606). This may be set in various ways, including for example, by increasing the current segment size by a set amount, such as 1, or some other value, or by setting it based on the context size. For example, the segment size may be set as \sqrt{t}. Once the segment size is changed, all of the current segments will need to be recalculated using the new segment size. All of the keys of the current context are considered and the processing begins with the first key (608). A random feature mapping is applied to the current key (610) which is then combined with the current segment (612). The method 600 determined whether the current segment length is equal to the new maximum length (614). If the current segment length is not equal to the maximum length (No at 614) the next key is retrieved (616) and processed (610). If the current segment length is equal to the maximum length (Yes at 614), the current segment length is reset (618) and a new segment is started (620). The next key can be retrieved (616) and processed into the new segment. Keys continue to be added to the segments until all of the keys are processed. If there are no more keys to process, the segments may be stored and subsequently processed (622) as described above.

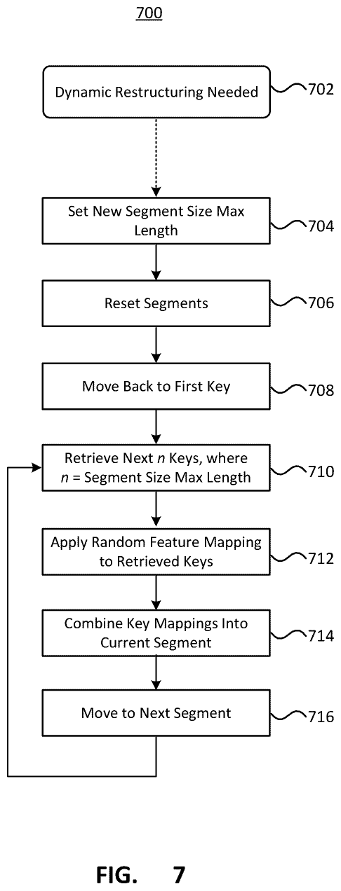

FIG. 7 depicts a further method of dynamic restructuring of segment size used in the feast-long context mechanism. The method 700 is similar to the method 600 described above, however rather than processing keys as they are retrieved, the process 700 can process all of the current keys when restructuring is required. When it is determined that dynamic restructuring is needed (702), a new segment size max length is set (704), which as described above can be done in various ways. With the new segment length set, the current segments are reset (706), and processing of the keys begins with the first key of the context (708). The next n keys are retrieved from the context (710), where n=segment size. The random feature mapping is applied to the retrieved keys (712) and then combined together into the current segment (714). The next segment (716) is then generated using the next n keys in the context.

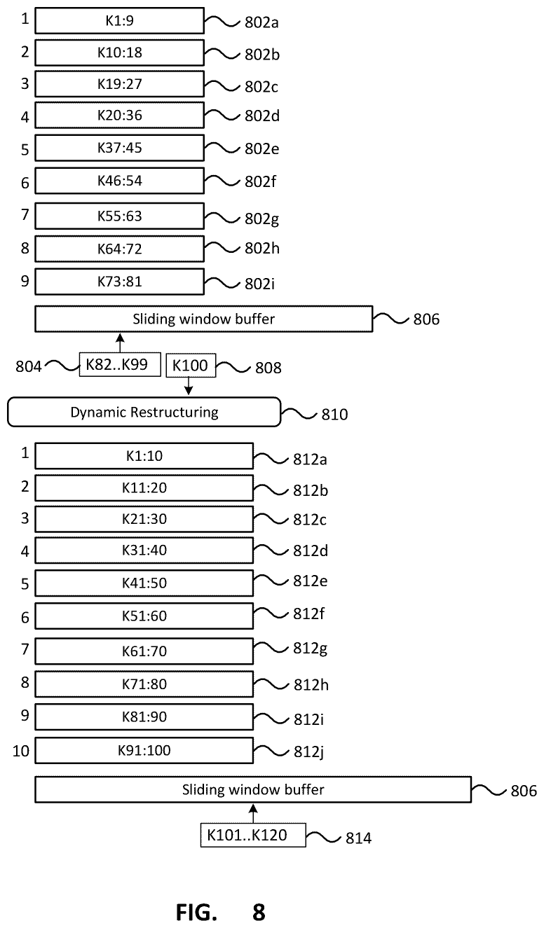

FIG. 8 depicts the dynamic restructuring of segments. As depicted in FIG. 8, a number of segments 1 . . . 9 802a . . . 802i have been generated based on keys K1 . . . . K81 of the context. As new keys K82 . . . . K99 are retrieved, they are added to the sliding window buffer 806. When the next key K100 808 is received it is determined that a dynamic restructuring of the segments is needed 810. It is noted that in this case, the dynamic restructuring is determined to be necessary since t=100, \sqrt{t}=10, and 10∈N. During the restructuring, the segment size is increased to 10 and 10 segments 1 . . . 10 812a . . . 812j calculated from the current context of 100 keys. As new keys 814 are received, they again can be added to the sliding window buffer 806.

As described above, it is possible increase the context size of a trained model efficiently. An algorithm of the overall process is described in pseudo code below.

Algorithm 1: Overall algorithm of the
range-search accelerated key selection

```
Require:
head dimension d ∈ [symbol]    ;
projection dimension n ∈ [symbol]    ;
number of segments to select k ∈ [symbol]
Process:
Initialize state
Current context length t ← 0
Current segment range c ← 0
Unregistered buffer [symbol]     ← Ø
Sample Ω = (ω₁, ... , ωₙ) from [symbol]    _{0,1}
Obtain projection function φ_{Ω} according to eqn. (4)
Decoding procedure
While taking a new token with q, k and v do
  t ← t + 1
  If √t ∈ [symbol]     then
    dynamic restructure
    c ← √t
    Pre-calculate φ_{Ω}(k_{i:i+c}) for i ∈ [1,1 + c, 1 + 2c, ... ,1 + (c − 1)c] [symbol]
    ← Ø
  Else [symbol]
    ← [symbol]     ∪ {t}
  End if
  Querying procedure
  For i ∈ [1,1 + c, 1 + 2c, ... ,1 + (c − 1)c] do
    Calculate segment attentions according to eqn. (6)
      α_{i:i+c} := φ_{Ω}^{T}(q)φ̅_{Ω}(k_{i:i+c})
  End for
  Pick indices [symbol]     in the k segments with the highest α_{i:i+c} [symbol]
  + [symbol]     ∪ [symbol]
  Yield softmax (q^{T}k [symbol]   /√d)v [symbol]
End while
```

As long as the projection dimension n of the random feature mapping function is large enough it is possible to recover the segment with the highest attention up to any precision. With the growth of the sequence length, the condition would not be difficult because the attention gap needed is

$$O ( \frac{log ( c )}{c} )$$

for an average attention of O(1/c).

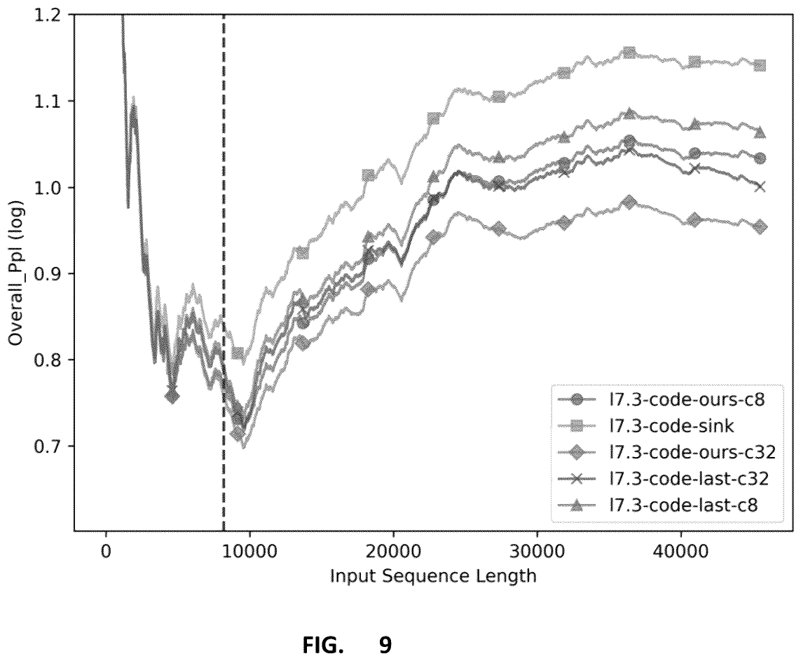

FIG. 9 is a results graph showing the perplexity vs. input sequence length; and

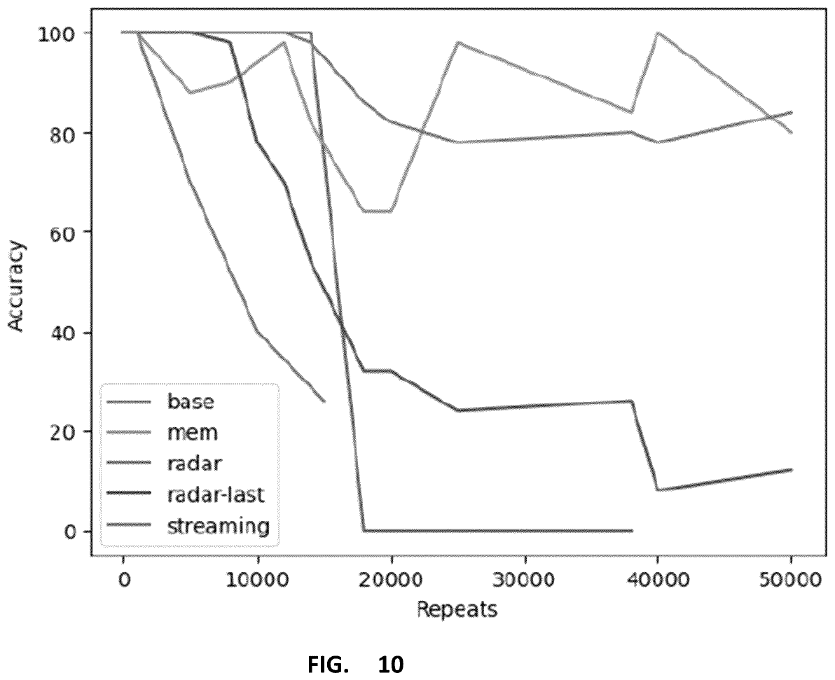

FIG. 10 is a result graph showing the accuracy vs. number of repeats.

The fast long-context processing described above was compared against other models. In evaluating the fast long-context processing, the perplexity on the first sample in the PG-19 dataFlset as the main test bed. The overall perplexity was evaluated by feeding the ground-truth tokens one by one. Since PG-19 only contained natural language, a code sample from The Stack was additionally used for a broader comparison. The selected sample was an implementation of NASA's CDF Project (https://cdf.gsfc.nasa.gov/) in a single Python file. To simulate the real-world use cases, the first 16,384 tokens were prefilled into the model as a prompt.

In evaluating he fast-long context processing perplexity, the vanilla dot-product attention and StreamingLLM were used as the baselines. The sliding window length was set to 1024 for all runs. For the fast long-context processing method, the top 64 segments for each query with the random projection dimension set to 2048. Each experiment was conducted on a single A100 GPU with 40 GB of memory.

Two popular architectures were considered in evaluating the fast long-context processing, namely Llama and Mistral. Specifically, Llama-Meta-3.1-8B and Mistral-7B-v0.3 were used for each architecture, respectively.

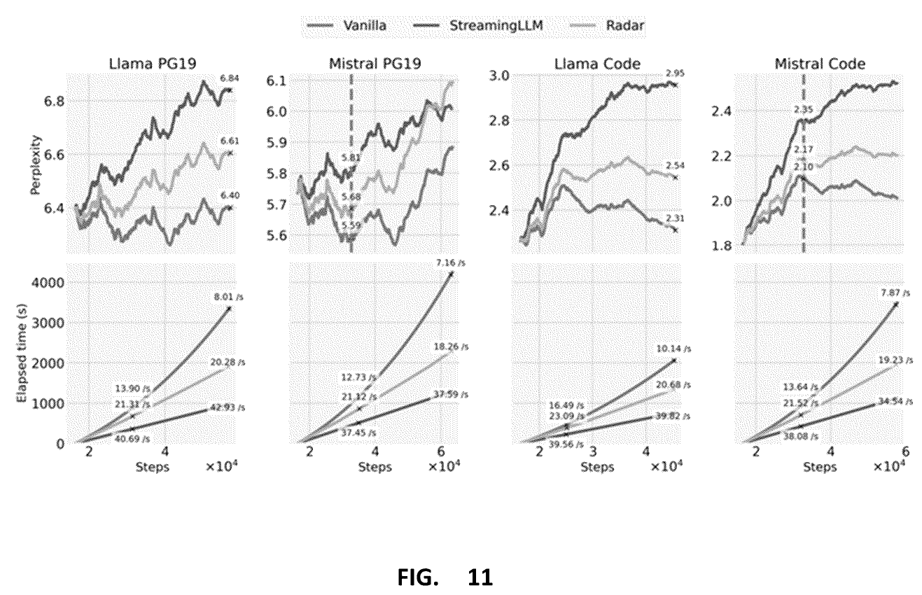

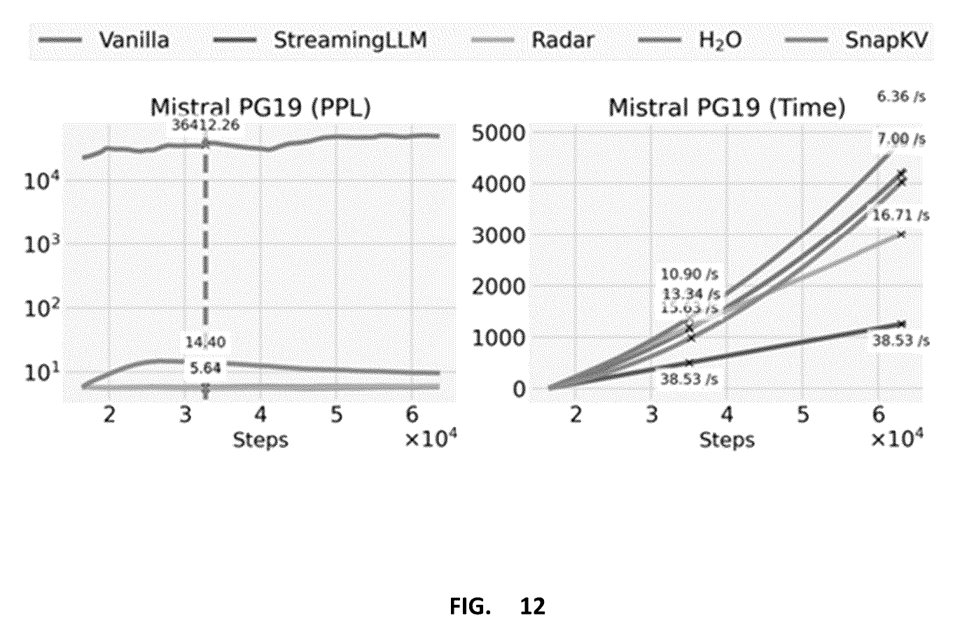

The results were depicted in FIG. 11. The performance comparison in perplexity depicted in the upper row and elapsed time in the lower row. In the results, lower the better for both metrics. For the Llama model, the perplexity value at the last token was annotated; for the Mistral model, the perplexity at the maximum pre-training context length, shown by the vertical dashed lines, was annotated because the full context exceeded its modeling ability. Additionally the generation throughput was shown for all runs. Additional results with H2O and SnapKV were depicted in FIG. 12. H2O and SnapKV were two state-of-the-art methods that employed different heuristics to reduce context length during inference as both methods produced out-of-scale perplexities in this setting.

The naive attention method achieved the best perplexity in all runs. However, its elapsed time grew quadratically regardless of the architecture. In practice, the generation throughput dropped to 10 tokens/s or even lower at the end. On the other hand, StreamingLLM achieved a constantly high throughput at a cost of poor generation quality (measured in perplexity), as it evicted most of the context during generation.

In contrast, the fast long-context processing method was able to effectively control the elapsed time while maintaining a similar perplexity by a maximum difference of around 0.2 compared with the vanilla attention. Notably, the performance degeneration of the fast long-context processing method was at most 10% while the speed up was more than 2 times. The results confirmed the effectiveness of the fast long-context processing method in effectively utilizing the context while accelerating inference.

For a more comprehensive comparison, the end-to-end evaluation on numerous long-context tasks was additionally conducted.

The LongBench dataset is used as the main benchmark. Specifically, all 16 subtasks in English and code languages were used. These tasks belonged to 6 categories in total: single-doc QA, multi-doc QA, summarization, few-shot learning, synthetic, and code. The context was truncated from the middle if the prompt length exceeded the pre-training length. Each subtask was evaluated with a specific metric. After evaluating all subtasks, the average scores were reported as a summary on LongBench. It was worth noting that the metrics used by different subtasks could have very different scales, indicating the arithmetic average over all subtasks might not reflect the overall performance. To this end, the average percentile over all 16 tasks ranked within the same base model was additionally included. For instance, a percentile of 80% meant that the method was expected to be strictly better than 80% of other methods.

All methods mentioned in the previous section, including H2O and SnapKV, were used. All competing baselines could use a maximum of 32+n_c tokens, where 32 was the length of the sliding window and n_c was the number of middle tokens varied from 1024 to 4096. For StreamingLLM, the sliding window was simply extended by n_c. In addition to baselines used in previous work, Landmark attention and SubGen were also evaluated. Each experiment was conducted on one A100 GPU.

A wide range of models were tested in this experiment. The Llama-7b model was first chosen because Landmark attention was fine-tuned based on it. Llama-2-7b-chat-hf, which was included in the original LongBench paper, was also used. Mistral-7B-Instruct-v0.2 was also tested.

The results were shown in Table 1. In all three subtables, it's seen that the vanilla attention mechanism generally achieved the highest scores on all tasks, given that it had all the information presented in the context. StreamingLLM was oftentimes the worst method because it only used the recent 32+n_c tokens.

For the Llama-7b model, it was seen that the Landmark attention method performed better than the vanilla method on QA tasks. This was likely due to the additional data in fine-tuning. However, the performance on other tasks was significantly deteriorated. For H2O and SnapKV, it was observed that SnapKV was better than H2O in both average score and percentile. Among all the baselines, the fast long-context processing method achieved the highest average score and percentile ranking.

For the Llama-2-7b-chat-hf model, SnapKV generally outperformed H2O in this setting. SubGen, albeit additionally saving memory, underperformed other methods on nearly all tasks. This indicated that its emphasis on memory saving and acceleration might have been at the expense of generation quality. The fast long-context processing method achieved the highest average scores and average percentiles across all n_c settings. Notably, the fast long-context processing method with 1024 middle tokens outperformed SnapKV with 2048 middle tokens in terms of average score. The results strongly suggested the effectiveness of the fast long-context processing method in utilizing the context.

For the Mistral-7B-Instruct-v0.2 model, the fast long-context processing method was consistently better than SnapKV when the ground-truth answers required long generation (e.g., the government report task). This not only suggested the effectiveness of the fast long-context processing method but also showed that it was utilizing different tokens at different steps of token generation. Remarkably, the fast long-context processing method achieved an average score close to the vanilla method with only 13% of the tokens used (n_c=4096).

Tables 1 to 3 below provides performance comparisons of different methods on LongBench. On each model, the best-performing method was highlighted in bold and the second-best method was underlined (excluding the vanilla method). Each table contained the results for one particular model.

TABLE 1
depicts the LongBench benchmark results of different methods applied on Llama-7b.
Each prompt contains maximum 1.5K tokens as the model can handle maximum 2K tokens.

| | | Single QA | | | Multi QA | | | Summarization | | |
|---|---|---|---|---|---|---|---|---|---|---|
| Context | Method | NrtvQA | Qasper | MFQA | HtptQA | 2WkQA | Musique | GovRep | QMSum | MulNews |
| Full | Vanilla | 3.12 | 8.01 | 17.52 | 8.16 | 10.02 | 4.75 | 26.28 | 14.33 | 27.18 |
| — | Landmark | 8.53 | 10.51 | 16.05 | 10.97 | 12.61 | 4.54 | 11.93 | 11.88 | 7.16 |
| 1024 | StreamingLLM | 2.76 | 7.86 | 16.37 | 8.57 | 11.14 | 4.54 | 15.86 | 14.17 | 19.96 |
| | H₂O | 2.87 | 8.11 | 16.59 | 8.05 | 9.85 | 4.20 | 26.25 | 14.85 | 25.92 |
| | SnapKV | 2.97 | 7.88 | 17.38 | 8.39 | 10.07 | 4.65 | 25.74 | 14.51 | 26.55 |
| | Radar | 2.94 | 8.01 | 17.61 | 8.49 | 10.51 | 4.15 | 26.11 | 14.61 | 27.52 |

| | | Few-show | | | Synthetic | | Code | | Avg. | Avg. |
|---|---|---|---|---|---|---|---|---|---|---|
| Context | Method | TREC | TrivQA | SamSum | PsgCnt | PsgRet | LCC | RB-P | Score | Perc. |
| Full | Vanilla | 52.50 | 80.88 | 35.16 | 2.00 | 6.17 | 61.88 | 54.81 | 25.80 | 56.25 |
| — | Landmark | 34.00 | 58.83 | 28.93 | 2.50 | 5.83 | 45.24 | 39.39 | 19.31 | 30.21 |
| 1024 | StreamingLLM | 53.00 | 80.79 | 35.44 | 1.83 | 6.50 | 61.81 | 53.97 | 24.66 | 37.50 |
| | H₂O | 51.50 | 80.67 | 34.41 | 1.50 | 5.75 | 60.06 | 52.96 | 25.22 | 25.00 |
| | SnapKV | 52.50 | 80.88 | 35.24 | 2.00 | 6.17 | 62.71 | 54.47 | 25.76 | 52.08 |
| | Radar | 52.00 | 80.92 | 35.48 | 1.75 | 6.50 | 62.36 | 54.41 | 25.84 | 54.17 |

TABLE 2
depicts the LongBench benchmark results of different methods applied on Llama-2-7b-chat-hf.
Each prompt contains maximum 3.5K tokens as the model can handle maximum 4K tokens.

| | | Single QA | | | Multi QA | | | Summarization | | |
|---|---|---|---|---|---|---|---|---|---|---|
| Context | Method | NrtvQA | Qasper | MFQA | HtptQA | 2WkQA | Musique | GovRep | QMSum | MulNews |
| Full | Vanilla | 16.87 | 17.78 | 36.13 | 34.06 | 27.53 | 9.10 | 26.09 | 21.01 | 25.99 |
| | SubGen | 15.98 | 19.54 | 26.27 | 17.00 | 21.49 | 7.38 | 22.80 | 20.68 | 23.90 |
| 1024 | StreamingLLM | 15.38 | 15.13 | 21.95 | 28.67 | 24.56 | 5.66 | 21.15 | 19.70 | 24.57 |
| | H₂O | 16.54 | 16.04 | 35.14 | 32.53 | 26.60 | 8.11 | 27.91 | 20.42 | 26.84 |
| | SnapKV | 15.69 | 18.30 | 35.59 | 33.23 | 26.27 | 8.62 | 21.81 | 20.47 | 25.18 |
| | Radar | 16.95 | 19.32 | 37.20 | 33.70 | 27.60 | 8.83 | 25.30 | 21.21 | 25.66 |
| 2048 | StreamingLLM | 16.77 | 16.03 | 25.45 | 30.14 | 25.36 | 7.42 | 23.59 | 19.71 | 25.58 |
| | H₂O | 16.39 | 17.93 | 36.09 | 32.88 | 26.47 | 7.61 | 27.73 | 20.58 | 26.45 |
| | SnapKV | 17.05 | 18.43 | 36.03 | 33.78 | 27.06 | 7.90 | 24.56 | 21.01 | 25.76 |
| | Radar | 16.90 | 17.76 | 36.02 | 33.90 | 26.81 | 8.79 | 26.32 | 21.11 | 26.15 |

| | | Few-shot | | | Synthetic | | Code | | Avg. | Avg. |
|---|---|---|---|---|---|---|---|---|---|---|
| Context | Method | TREC | TrivQA | SamSum | PsgCnt | PsgRet | LCC | RB-P | Score | Perc. |
| Full | Vanilla | 64.00 | 83.84 | 41.24 | 4.50 | 12.00 | 58.36 | 52.31 | 33.18 | 74.38 |
| | SubGen | 39.00 | 65.31 | 25.95 | 1.84 | 4.92 | 44.23 | 43.32 | 24.98 | 13.75 |
| 1024 | StreamingLLM | 61.00 | 80.69 | 40.62 | 4.58 | 4.50 | 56.59 | 49.28 | 29.63 | 14.37 |
| | H₂O | 63.00 | 83.15 | 38.38 | 4.00 | 10.50 | 52.11 | 44.53 | 31.61 | 36.25 |
| | SnapKV | 64.50 | 82.57 | 40.43 | 4.50 | 11.00 | 58.27 | 52.06 | 32.41 | 45.00 |
| | Radar | 63.50 | 83.44 | 40.78 | 4.50 | 10.00 | 57.70 | 51.17 | 32.93 | 64.38 |
| 2048 | StreamingLLM | 64.00 | 82.57 | 41.65 | 4.50 | 6.50 | 56.94 | 51.15 | 31.08 | 35.00 |
| | H₂O | 63.50 | 83.78 | 39.26 | 4.50 | 10.00 | 57.32 | 51.63 | 32.63 | 50.00 |
| | SnapKV | 64.00 | 82.88 | 40.60 | 4.50 | 11.50 | 58.51 | 51.74 | 32.83 | 64.38 |
| | Radar | 64.00 | 83.92 | 41.01 | 4.50 | 11.50 | 58.37 | 52.06 | 33.07 | 71.25 |

TABLE 3
the LongBench benchmark results of different methods applied on Mistral-7B-Instruct-v0.2.
Each prompt contains maximum 31.5K tokens as the model can handle maximum 32K tokens.

| | | Single QA | | | Multi QA | | | Summarization | | |
|---|---|---|---|---|---|---|---|---|---|---|
| Context | Method | NrtvQA | Qasper | MFQA | HtptQA | 2WkQA | Musique | GovRep | QMSum | MulNews |
| Full | Vanilla | 27.06 | 32.22 | 49.61 | 43.49 | 27.96 | 18.85 | 33.35 | 24.30 | 27.13 |
| 1024 | StreamingLLM | 21.70 | 18.95 | 32.03 | 32.72 | 21.69 | 11.89 | 23.55 | 20.28 | 25.41 |
| | SnapKV | 24.97 | 30.03 | 49.51 | 41.35 | 25.82 | 18.92 | 25.85 | 24.09 | 26.24 |
| | Radar | 23.81 | 28.26 | 47.91 | 38.96 | 26.17 | 16.08 | 27.99 | 22.52 | 26.95 |
| 2048 | StreamingLLM | 22.54 | 22.46 | 35.35 | 33.36 | 23.11 | 13.30 | 26.60 | 20.67 | 26.47 |
| | SnapKv | 26.10 | 32.14 | 49.31 | 41.71 | 27.60 | 18.83 | 28.90 | 24.53 | 26.65 |
| | Radar | 26.31 | 31.89 | 49.55 | 43.18 | 26.83 | 17.47 | 30.38 | 23.30 | 27.18 |
| 4096 | StreamingLLM | 24.48 | 29.86 | 41.04 | 37.19 | 24.47 | 14.94 | 30.38 | 21.62 | 26.96 |
| | SnapKV | 26.31 | 33.61 | 50.35 | 42.67 | 27.89 | 18.74 | 30.73 | 24.24 | 27.00 |
| | Radar | 26.31 | 33.77 | 49.17 | 42.85 | 28.68 | 17.91 | 32.15 | 24.17 | 27.11 |

| | | Few-shot | | | Synthetic | | Code | | Avg. | Avg. |
|---|---|---|---|---|---|---|---|---|---|---|
| Context | Method | TREC | TrivQA | SamSum | PsgCnt | PsgRet | LCC | RB-P | Score | Perc. |
| Full | Vanilla | 71.00 | 86.07 | 43.50 | 2.80 | 86.98 | 56.17 | 53.63 | 42.76 | 75.63 |
| 1024 | StreamingLLM | 64.00 | 84.95 | 42.13 | 3.13 | 22.33 | 54.79 | 49.94 | 33.09 | 8.75 |
| | SnapKV | 70.00 | 86.53 | 42.04 | 2.83 | 89.06 | 54.33 | 50.96 | 41.41 | 43.75 |
| | Radar | 70.50 | 85.94 | 41.70 | 3.13 | 53.33 | 54.17 | 50.03 | 38.59 | 28.75 |
| 2048 | StreamingLLM | 66.00 | 85.92 | 42.00 | 2.81 | 26.58 | 55.92 | 51.58 | 34.67 | 18.75 |
| | SnapKy | 70.50 | 86.28 | 42.97 | 2.78 | 86.27 | 54.50 | 50.87 | 41.87 | 51.87 |
| | Radar | 71.50 | 86.15 | 42.49 | 3.39 | 72.25 | 55.76 | 51.87 | 41.22 | 60.00 |
| 4096 | StreamingLLM | 69.50 | 86.15 | 42.70 | 2.58 | 39.53 | 56.49 | 52.64 | 37.53 | 34.38 |
| | SnapKV | 71.00 | 86.25 | 43.14 | 2.60 | 86.10 | 54.19 | 51.22 | 42.25 | 61.25 |
| | Radar | 71.00 | 86.23 | 43.41 | 2.87 | 81.75 | 56.42 | 52.92 | 42.30 | 69.38 |

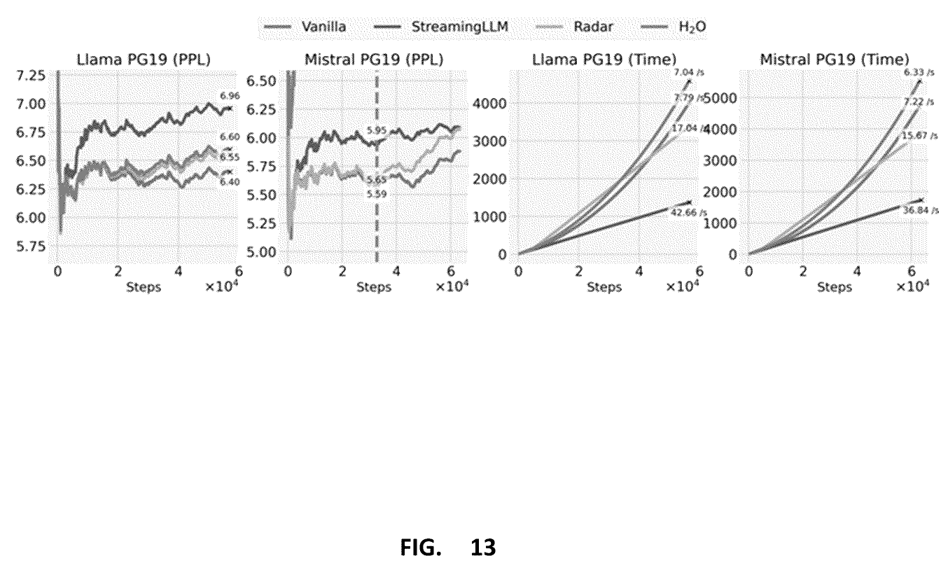

In the perplexity evaluation above 16,384 tokens were prefilled for all runs to simulate the usage of prompts in real-world applications. However, some previous work focused on non-conditional generation, where no prompt was provided. To compare the performance in this setting, experiments similar to the perplexity evaluations without the prompts were conducted. The results are shown in FIG. 13. Note that a comparison with SnapKV could not be made because it was only applied to prompts.

As observed, H2O demonstrated a promising result on the Llama model. The overall perplexity was only worse than the fast long-context processing method by 0.05. However, the perplexity of the Mistral model started to drastically deteriorate after hundreds of tokens. On the contrary, the current fast long-context processing method continued to perform steadily. This experiment suggested the versatility of the fast long-context method, offering acceleration with or without prompts on a wide range of model architectures.

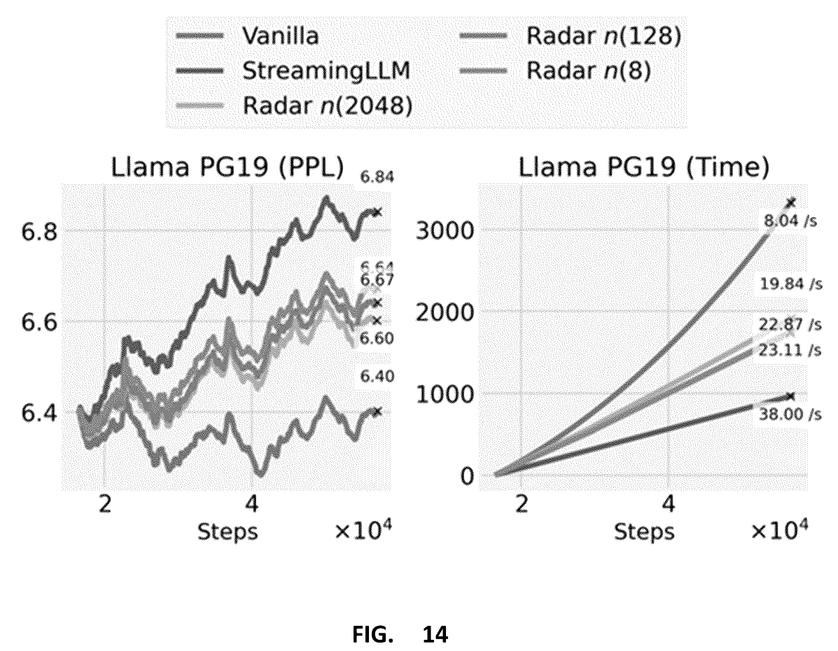

The fast long-context method introduced hyper-parameters n, which is the projection dimension for the random matrix and k, which is the number of top segments selected. The effect of these two hyper-parameters is shown in FIGS. 14 and 13, respectively.

Aligned with the theoretical prediction, increasing n improved the performance by providing better attention approximation. Similarly, increasing k also improved the generation quality by using more tokens. However, a high n or k imposed the need for more memory and increased the computational overhead. Given these considerations, n=2048 and k=64 were used by default to balance the generation quality and hardware efficiency.

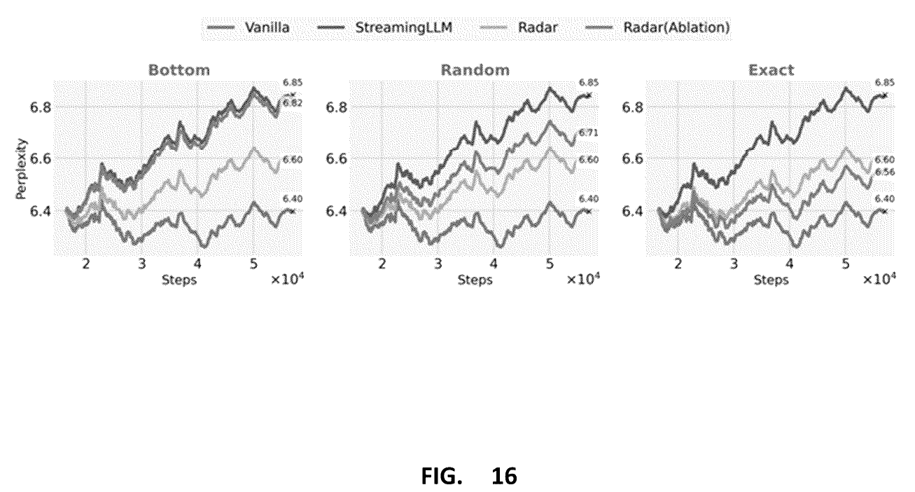

The fast long-context processing algorithm involved an approximated top-k selection. To verify that such an approximation was functioning as intended, three ablation studies were conducted, as shown in FIG. 16 by replacing it with three other strategies. The experiments were conducted with the Llama model on the PG-19 sample.

As shown, when segments with the lowest approximated segment attention scores were selected, the performance became similar to StreamingLLM, suggesting that the selected tokens with low segment attention scores were indeed not informative. In addition, this approximation was better than the random selection strategy (middle), showing that such an approximation was choosing more informative tokens than the “uneducated guess”. Lastly, it was seen that the approximation had the closest performance compared with the exact segment search (right), indicating the fast long-context processing method, albeit potentially missing some tokens, was a reasonable approximation given its low time complexity.

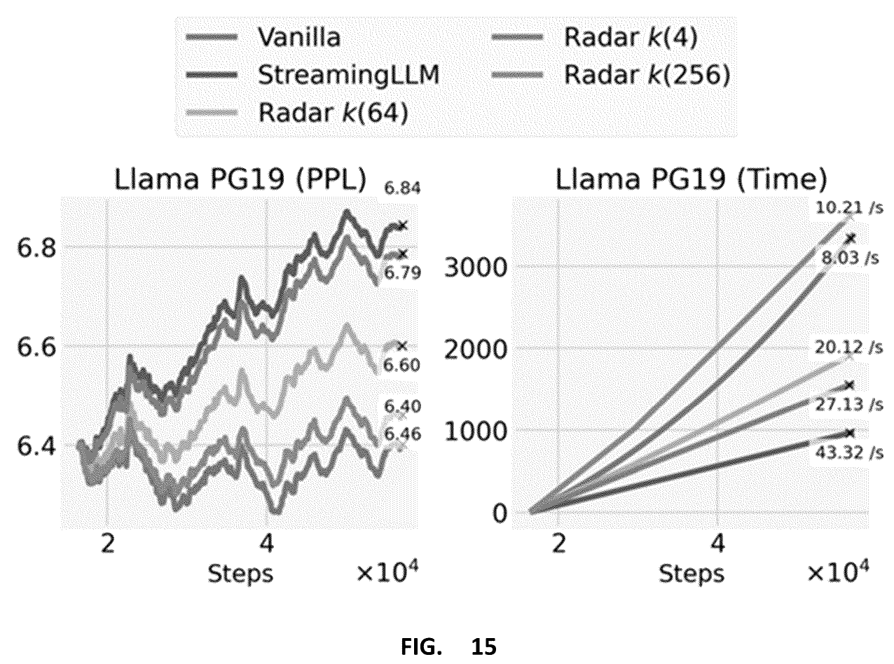

It will be appreciated by one of ordinary skill in the art that the system and components shown in FIGS. 1-16 may include components and/or steps not shown in the drawings. For simplicity and clarity of the illustration, elements in the figures are not necessarily to scale, are only schematic and are non-limiting of the elements and structures. It will be apparent to persons skilled in the art that a number of variations and modifications can be made without departing from the scope of the invention as defined in the claims.

Although certain components and steps have been described, it is contemplated that individually described components, as well as steps, may be combined together into fewer components or steps or the steps may be performed sequentially, non-sequentially or concurrently. One or more features, components, and/or elements may be described with reference to a particular embodiment. Such features, components and/or elements can be incorporated into and/or combined with other embodiments. Further, although described above as occurring in a particular order, one of ordinary skill in the art having regard to the current teachings will appreciate that the particular order of certain steps relative to other steps may be changed. Similarly, individual components or steps may be provided by a plurality of components or steps. One of ordinary skill in the art having regard to the current teachings will appreciate that the components and processes described herein may be provided by various combinations of software, firmware and/or hardware, other than the specific implementations described herein as illustrative examples.

The techniques of various embodiments may be implemented using software, hardware and/or a combination of software and hardware. Various embodiments are directed to apparatus, e.g. a node which may be used in a communications system or data storage system. Various embodiments are also directed to non-transitory machine, e.g., computer, readable medium, e.g., ROM, RAM, CDs, hard discs, etc., which include machine readable instructions for controlling a machine, e.g., processor to implement one, more or all of the steps of the described method or methods.

Numerous additional variations on the methods and apparatus of the various embodiments described above will be apparent to those skilled in the art in view of the above description. Such variations are to be considered within the scope of the current disclosure.

What is claimed is:

1. A method for use in determining context keys for an attention mechanism of a transformer model, the method comprising:
generating a plurality of segments, each segment combining a plurality of respective token key mappings generated by mapping the respective token keys using a random feature matrix Ω∈ [symbol] ^{n×d};
generating a token query mapping by mapping the token query using the random feature matrix Ω;
calculating attention scores between the token query mapping and each of the plurality of segments; and
returning the token keys of m segments with the highest attention scores.

2. The method of claim 1, wherein the random feature matrix is Ω∈ [symbol] ^{n×d}, where each element in Ω is sampled from [symbol] _{0,1}.

3. The method of claim 2, wherein each token key mapping is calculated according to:
$${ϕ}_{Ω} ( k ) := \frac{1}{\sqrt{n}} ( exp ( {ω}_{1}^{T} k - \frac{{‖ k ‖}^{2}}{2} ) , exp ( {ω}_{2}^{T} k - \frac{{‖ k ‖}^{2}}{2} ) , … , exp ( {ω}_{n}^{T} k - \frac{{‖ k ‖}^{2}}{2} ) )$$
where:
k∈ [symbol] ^{d} is the token key;
ωᵢ∈ [symbol] ^{d} is the i^{th} column of Ω.

4. The method of claim 3, wherein each segment is generated according to:
$${\overline{ϕ}}_{Ω} ( {k}_{j : j + c} ) := \frac{1}{c + 1} {\sum }_{l = 0}^{c} {ϕ}_{Ω} ( {k}_{j + l} )$$
where:
the number of key tokens combined in the segment is c+1.

5. The method of claim 4, wherein the attention score is calculated according to:
$${a}_{l : l + c} := {ϕ}_{Ω}^{T} ( q ) {\overline{ϕ}}_{Ω} ( {k}_{l : l + c} )$$
where:
a_{l:l+c} is the attention score for the segment of token keys kₗ to k_{l+c}.

6. The method of claim 1, wherein each segment is formed from at most c+1 token keys.

7. The method of claim 6, further comprising:
receiving a new token key and new token query;
mapping the new token key and new token query to, respectively, a new token key mapping and a new token query mapping using the random feature matrix;
adding the new token key mapping to a sliding window buffer;
calculating attention scores between the new token query mapping and each of the plurality of segments; and
returning the token keys of m segments with the highest attention scores and the token keys of the token key mappings in the sliding window buffer.

8. The method of claim 6, further comprising:
receiving a new token key and new token query;
mapping the new token key and new token query to, respectively, a new token key mapping and a new token query mapping using the random feature matrix;
combining the new token key mapping with an existing segment;
calculating attention scores between the new token query mapping and each of the plurality of segments; and
returning the token keys of t segments with the highest attention scores.

9. The method of claim 7, further comprising:
determining that the plurality of segments should be dynamically restructured;
determining a new segment length (c′) indicating a maximum number of token key mappings combined together in each new segment; and
calculating the new segments according to:
$${\overline{ϕ}}_{Ω} ( {k}_{j : j + {c}^{′} - 1} ) := \frac{1}{{c}^{′}} {\sum }_{l = 0}^{{c}^{′} - 1} {ϕ}_{Ω} ( {k}_{j + l} ) .$$

10. The method of claim 9, wherein determining that the plurality of segments should be dynamically restructured comprises:
calculating \sqrt{t};
determining that dynamic restructuring is required when \sqrt{t}∈N; and
determining that dynamic restructuring is not required otherwise,
where
t is a total number of tokens in a current context.

11. The method of claim 9, wherein determining that the plurality of segments should be dynamically restructured comprises one or more of:
determining that the number segments has exceeded a threshold; and
determining that a ratio of the number of segments to the segment length has exceeded a threshold.

12. A system for use in determining context keys for an attention mechanism of a transformer model, the system comprising:
a processor for executing instructions;
a memory storing instructions, which when executed by the processor configure the system to provide a method according to claim 1.

13. A non-transitory computer readable memory storing instructions, which when executed by a processor of a system configure the system to provide a method according to claim 1.
